(19) United States
(12) Patent Application Publication
(10) Pub. No.: US 2009/0202673 A1
(43) Pub. Date: Aug. 13, 2009

(54) CHEWING GUM PRODUCTS

(75) Inventors: David R. Phillips, Chicago, IL (US); Kevin B. Broderick, Berwyn, IL (US); Jose Cardenas, Crown Point, IN (US); Donald A. Seielstad, Frankfort, IL (US); Barbara Z. Stawski, Forest Park, IL (US)

Correspondence Address: WRIGLEY & DREYFUS 28455;BRINKS HOFER GILSON & LIONE, P.O. BOX 10395, CHICAGO, IL, 60610, US

(73) Assignee: Wm. Wrigley, Jr. Company, Chicago, IL (US)

(21) Appl. No.: 12/375,390

(22) PCT Filed: Jul. 31, 2007
(86) PCT No.: PCT/US07/74893

§ 371 Date: Jan. 27, 2009

(30) Foreign Application Priority Data
Jul. 31, 2006 (US) 60834759

(51) Int. Cl. A23G 4/20

(52) U.S. Cl. 426/5

(57) ABSTRACT

A chewing gum composition contains a gum base; 0% to about 60%, preferably about 10% to about 50%, bulking and sweetening agents; and about 5% to about 80% fat-containing confection, such as chocolate. The gum base comprises about 2% to about 40% elastomer, about 10% to about 50% elastomer plasticizer, about 2% to about 35% gum base softener, and about 1% to about 10% emulsifier. The gum base usually contains less than 10% filler, and less than 45% gum base matrix disrupting materials. In another embodiment, the chewing gum product is made from gum base and flavoring agents, possibly without the addition of any bulk sweetening agents. A chewing gum product can be formed from the composition. The product may be a compressed gum product. In another embodiment, the product can be coated or filled with a fat-containing confection, such as chocolate, in which case the product may be made of a composition without the fat-containing confection in it and with 0% to about 60% bulking and sweetening agent. The fat-containing confection may comprise up to about 90% of such a product, where the fat-containing confection and chewing gum are in distinct regions. A chewing gum center coated with fat-containing confection and further covered with a hard shell coating is depicted.

### REFERENCE TO EARLIER FILED APPLICATION

The present application claims the benefit of the filing date under 35 U.S.C. § 119(e) of Provisional U.S. Patent Application Ser. No. 60/834,759, filed Jul. 31, 2006, which is hereby incorporated by reference in its entirety.

### BACKGROUND

Chewing gum is a widely produced confectionery that is very desirable, in part because people enjoy having a product that they can chew and that is sweet and flavorful. Part of the benefit of chewing gum is that it is made with a water-insoluble chewing gum base which remains in the mouth and can be chewed for a long period of time.

Chocolate and other fat-containing confections such as caramel and toffee also have a wide appeal. Chocolate flavoring is used in many confectionery products, and chocolate, either by itself or as a coating on other products, is widely consumed.

There have been attempts to combine chocolate and chewing gum. Chocolate flavored chewing gums have been made before. But when chocolate itself has been combined with chewing gum, either as an ingredient in the chewing gum or as a coating for a chewing gum pellet, the high fat content of the chocolate has caused a problem in trying to have the desirable result of a masciatory substance that remains in the mouth and can be chewed for a period of time. The chewing gum with chocolate prepared from the conventional chewing gum base becomes very soft or dissolves when chewed, and tends to be swallowed without leaving any chewing residue. It has been believed that this softening or dissolution phenomenon of the gum is caused by the fatty cocoa butter contained in chocolate. Cocoa butter typically is present in chocolate in an amount of approximately 25% to 40%.

A number of products have been proposed to deal with this problem. A chewing gum that is flavored with cocoa powder or chocolate flavor free of fatty matter is one solution; however, this does not provide the true flavor and mouth feel of chocolate. Others have suggested an increase in the amount of rubber elastomer to counteract the amount of fatty matter coming from the natural chocolate. However, a high rubber content increases the cost of the product, and affects the chew characteristics of the product.

It would be advantageous if a chocolate chewing gum product could be made that could include a high level of chocolate. It would also be advantageous if a chocolate chewing gum product could be made with a gum base that uses conventional levels of typical gum base ingredients. It would also be advantageous if a tab or stick chewing gum product could be enrobed with a chocolate coating to provide a chocolate product, but the product, when chewed, still provide a water-insoluble chewing gum base which remains in the mouth and can be chewed for a long period of time. It would further be advantageous if each of these same products could be made with chewing gum and a fat-containing confection other than chocolate.

### SUMMARY OF THE INVENTION

It has surprisingly been found that a gum base developed for environmentally friendly chewing gum products is able to be used to make chewing gum products containing chocolate. One of the primary characteristics of these gum bases is that they contain essentially no non-silica fillers, such as talc and calcium carbonate. The same gum base that was found to have reduced adhesion as compared to typical chewing gum compositions can also be used to make chocolate chewing gum products that have suitable chew characteristics. Further investigation has identified other gum base ingredients, besides fillers, that disrupt the gum base matrix, and lead to the gum base falling apart when used in a chocolate-containing chewing gum products. As a result, additional gum base formulas have been invented that can be used to make chocolate chewing gum products that retain a cohesive gum base in the mouth when chewed. These same gum bases can also be used to make products that contain chewing gum and fat-containing confections other than chocolate.

The chewing gum products of embodiments of the invention can have chocolate mixed into the gum composition, or the chocolate can be included separately in the product. One particular embodiment is a product that has a chewing gum center, covered by chocolate, and a hard outer shell. The inventive chewing gum formulation, when prepared as a stick gum or tab type form, can be enrobed with chocolate similar to enrobing of confectionery bars. Although one of the inventive chewing gum formulations disclosed herein is preferred, other gum formulations developed for the use of chocolate in gum such that the gum does not dissolve when chewed may also be used with this aspect of the invention. Other fat-containing confections can be utilized in other embodiments of the invention just as chocolate is used, or with chocolate.

A chewing gum composition has been invented that is made with a gum base that contains a reduced level of gum base disrupting components. In a first embodiment, the invention is a chocolate containing chewing gum product comprising a) at least one piece of gum fashioned from a chewing gum composition comprising a gum base comprising i) about 2% to about 40% elastomer; ii) about 10% to about 50% elastomer plasticizer, the combination of elastomer and elastomer plasticizer being at least 30% of the gum base; iii) about 5% to about 35% gum base softener; and iv) about 1% to about 10% emulsifier; v) the gum base containing less than 10% filler and vi) the gum base containing less than 45% gum base matrix disrupting materials; and 0% to about 60%, by weight of the gum piece, bulking and sweetening agents; and b) chocolate. Alternatively, the product can be made with a fat-containing confection other than, or in addition to, the chocolate.

In a second embodiment, the invention is a chocolate coated chewing gum product comprising a chewing gum center; a first coating surrounding the confectionery center and comprising chocolate; and a second coating surrounding the first coating and comprising a hard shell made from one or more sugars, polyols and mixtures thereof. Rather than chocolate, the product can also be made with a different fat-containing confection.

In a third embodiment, the invention is a chewing gum composition comprising a) a gum base comprising i) about 2% to about 40% elastomer, ii) about 10% to about 50% elastomer plasticizer, the combination of elastomer and elastomer plasticizer being at least 30% of the gum base; iii) about 5% to about 35% gum base softener; and iv) about 1% to about 10% emulsifier; v) the gum base containing less than 10% filler; vi) the gum base containing less than 45% gum base matrix disrupting materials; b) about 0% to about 60% bulking and sweetening agents; and c) about 5% to about 50% chocolate, the chocolate including at least 20% fat by weight of the chocolate, and the chocolate being admixed into the chewing gum composition.

In a fourth embodiment, the invention is a combined fat-containing confection and chewing gum product comprising a) at least one piece of chewing gum formed from a chewing gum composition and comprising a first region of the product, the chewing gum composition comprising i) gum base comprising at least one elastomer and at least one elastomer plasticizer, ii) optional sweetener, and iii) flavoring; and b) fat-containing confection in a second region of the product, separate from the first region, wherein the amount of fat-containing confection in the product is at least 10%, by weight of the chewing gum in the product, greater than the amount of fat-containing confection that, if mixed homogeneously in the chewing gum, would cause the chewing gum base to lose its cohesiveness when such a homogeneous product is chewed.

In a fifth embodiment, the invention is method of producing a fat-containing confection coated chewing gum product comprising the steps of providing a chewing gum center; coating the chewing gum center with a first coating comprising fat-containing confection; and coating the first coating with a second coating comprising a hard shell made from one or more sugars, polyols and mixtures thereof.

In a sixth embodiment, the invention is a combined fat-containing confection and chewing gum product comprising a) at least one piece of chewing gum formed from a chewing gum composition and comprising a first region of the product, the chewing gum composition comprising i) gum base comprising at least one elastomer and at least one elastomer plasticizer, and less than 10% filler, ii) optional sweetener, and iii) flavoring; and b) fat-containing confection in a second region of the product, separate from the first region.

In a seventh embodiment, the invention is a combined fat-containing confection and chewing gum product comprising a) at least on piece of chewing gum fashioned from a chewing gum composition and comprising a first region of the product, the chewing gum composition comprising i) gum base comprising at least one elastomer and at least one elastomer plasticizer, ii) optional sweetener, and iii) flavoring; and b) a fat-containing confection other than chocolate in a second region of the product, separate from the first region.

In an eighth embodiment, the invention is a method of producing a combined fat-containing confection and chewing gum product comprising a) forming a piece of chewing gum from a chewing gum composition comprising i) gum base comprising at least one elastomer and at least one elastomer plasticizer, ii) optional sweetener, and iii) flavoring; and b) combining the piece of chewing gum with fat-containing confection in a manner selected from the group consisting of enrobing, moulding, depositing, liquid filling and extrusion, such that the piece of chewing gum comprises a first region of the product and the fat-containing confection comprises a second region of the product, separate from the first region.

In a ninth embodiment, the invention is a chewing gum composition comprising a) a gum base containing less than 40% gum base matrix disrupting materials; b) about 0% to about 60% bulking and sweetening agents; and c) about 5% to about 50% chocolate; wherein the amount of chocolate in the composition is at least 10%, by weight of the chewing gum in the composition, greater than the amount of chocolate that, if mixed homogeneously in the chewing gum, would cause the chewing gum base to lose its cohesiveness when such a homogeneous product is chewed if the gum base contained over 45% gum base matrix disrupting materials.

In a tenth embodiment, the invention is a chewing gum composition comprising a) a gum base comprising i) about 2% to about 40% elastomer, ii) about 10% to about 50% elastomer plasticizer, the combination of elastomer and elastomer plasticizer being at least 30% of the gum base; iii) about 5% to about 35% gum base softener; and iv) about 1% to about 10% emulsifier; v) the gum base containing less than 10% filler; vi) the gum base also containing less than 45% gum base matrix disrupting materials; b) about 0% to about 60% bulking and sweetening agents; and c) about 5% to about 50% fat-containing confection.

In an eleventh embodiment, the invention is a chewing gum composition comprising a) a gum base containing less than 40% gum base matrix disrupting materials; b) about 0% to about 60% bulking and sweetening agents; and c) about 5% to about 50% fat-containing confection; wherein the amount of fat-containing confection in the composition is at least 10% greater than the amount of fat-containing confection that, if mixed homogeneously in the chewing gum, would cause the chewing gum base to lose its cohesiveness when such a homogeneous product is chewed if the gum base contained over 45% gum base matrix disrupting materials.

In another embodiment, the invention is a combined chocolate and chewing gum product comprising a) at least one piece of chewing gum formed from a chewing gum composition and comprising a first region of the product, the chewing gum composition comprising i) gum base comprising at least one elastomer and at least one elastomer plasticizer, ii) optional sweetener, and iii) flavoring; and b) chocolate in a second region of the product, separate from the first region, the chocolate being tempered.

In yet another embodiment, the invention is a chewing gum composition comprising a) a gum base comprising i) about 2% to about 20% elastomer, ii) about 10% to about 40% elastomer plasticizer, iii) about 2% to about 25% gum base softener, and iv) about 2% to about 10% emulsifier, the gum base containing less than 1% non-silica filler; b) about 0% to about 60% bulking and sweetening agents; and c) about 5% to about 80% chocolate.

In a still further embodiment, the invention is a chewing gum composition comprising a) a gum base comprising i) high molecular weight polyisobutylene and ii) less than 1% non-silica filler; b) about 0% to about 60% bulking and sweetening agents; and c) about 5% to about 80% chocolate.

In another embodiment, the invention is a chocolate coated chewing gum product comprising a) at least one piece of gum fashioned from a chewing gum composition comprising i) a gum base comprising about 2% to about 20% elastomer, about 10% to about 40% elastomer plasticizer, about 2% to about 25% gum base softener, and about 2% to about 10% emulsifier, the gum base containing less than 1% non-silica filler; and ii) about 10% to about 60% bulking and sweetening agents; and b) a coating comprising chocolate on the piece of gum.

In another embodiment, the invention is a chocolate coated chewing gum product comprising a) at least one piece of gum fashioned from a chewing gum composition comprising i) a gum base comprising high molecular weight polyisobutylene and less than 1% non-silica filler; and ii) about 10% to about 60% bulking and sweetening agents; and b) a coating comprising chocolate on the piece of gum.

In another embodiment, the invention is a chocolate filled chewing gum product comprising a) a shell fashioned from a chewing gum composition comprising i) a gum base comprising about 2% to about 20% elastomer, about 10% to about 40% elastomer plasticizer, about 2% to about 25% gum base softener, and about 2% to about 10% emulsifier, the gum base containing less than 1% non-silica filler; and ii) about 10% to about 60% bulking and sweetening agents; and b) a filling in the shell comprising chocolate.

In a further embodiment, the invention is a chocolate filled chewing gum product comprising a) a shell fashioned from a chewing gum composition comprising i) a gum base comprising high molecular weight polyisobutylene and less than 1% non-silica filler; and ii) about 10% to about 60% bulking and sweetening agents; and b) a filling in the shell comprising chocolate.

In still another embodiment, the invention is a chocolate coated chewing gum product comprising at least one piece of gum fashioned from a chewing gum composition comprising a gum base comprising about 2% to about 20% elastomer, about 10% to about 40% elastomer plasticizer, about 2% to about 25% gum base softener, and about 2% to about 10% emulsifier, the gum base containing less than 1% non-silica filler; and about 0.1% to about 5% flavoring agents; and a coating comprising chocolate on the piece of gum.

In yet another embodiment, the invention is a chocolate coated chewing gum product comprising at least one piece of gum fashioned from a chewing gum composition comprising a gum base comprising high molecular weight polyisobutylene and less than 1% non-silica filler; and about 0.1% to about 5% flavoring agents; and a coating comprising chocolate on the piece of gum.

In a further embodiment, the invention is a chewing gum composition comprising a) a gum base comprising about 2% to about 20% elastomer, about 10% to about 40% elastomer plasticizer, about 2% to about 25% gum base softener, and about 2% to about 10% emulsifier, the gum base containing less than 1% non-silica filler; b) up to about 60% bulking and sweetening agents; and c) about 5% to about 80% of a fat content food selected from the group consisting of caramel, fudge, English toffee, chewy nougat, nut butters, grained caramel, hi-chew and combinations thereof.

Another embodiment of the invention is a method of producing a fat-containing confection coated chewing gum product comprising the steps of providing the chewing gum piece in a shape selected from the group consisting of a stick and a tab; and enrobing the piece with fat-containing confection cover by using a bottomer to coat the bottom of the gum piece and a curtain to cover the remaining sides of the gum piece.

Another embodiment of the invention includes a fat-containing confection coated chewing gum product comprising a chewing gum piece in a shape selected from the group consisting of a stick and a tab, enrobed with fat-containing confection.

It is surprisingly been found that gum bases that are limited in gum base matrix disrupting materials, such as non-silica fillers, provide a chewing gum composition in which the gum base does become soft, but does not fall apart even with the excess softeners like fats in chocolate added to the chewing gum composition, and the composition is chewed.

### BRIEF DESCRIPTION OF THE DRAWINGS

FIG. 1 is a perspective view of a product having chewing gum center, a first coating comprising chocolate, and a second coating comprising a hard shell coating.

FIG. 2 is a cross-sectional view taken along line 2-2 of FIG. 1.

FIG. 3 is a graph showing test results of the acceptable levels of chocolate that can be combined with certain gum bases compared to the combined percentage of elastomer and elastomer plasticizers in the gum base.

FIG. 4 is a graph showing test results of the acceptable levels of chocolate that can be combined with certain gum bases compared to the combined percentage of fillers and polyvinyl acetate in the gum base.

FIG. 5 is a photomicrograph showing a sample of gum base that has high levels of gum base matrix disrupting materials.

FIG. 6 is a photomicrograph showing a sample of gum base that also has gum base matrix disrupting materials.

FIG. 7 is a photomicrograph showing a sample of gum base that has very little gum base matrix disrupting materials.

### DETAILED DESCRIPTION OF THE PREFERRED EMBODIMENTS OF THE INVENTION

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

In the context of this invention, chewing gum refers to chewing gum, bubble gum and the like. Moreover, all percentages are based on weight percentages unless otherwise specified. Further, although some terms are referred to in the singular, it is understood that such references may also encompass the plural. For example, although chewing gum coating is referred to in the singular, it is understood that coated chewing gum normally contains multiple layers of coating. Therefore a phrase that refers to “the coating,” refers to one or more layers of coating. Finally, all references cited herein are incorporated by reference.

The term “chocolate” refers to a solid or semi-plastic food and is intended to refer to all chocolate or chocolate-like compositions containing a dispersion of solids within a fat phase. The term is intended to include compositions conforming to the U.S. Standards Of Identity (SOI), CODEX Alimentarius and/or other international standards and compositions not conforming to the U.S. Standards Of Identity or other international standards. The term includes sweet chocolate, bittersweet or semisweet chocolate, dark chocolate, milk chocolate, buttermilk chocolate, skim milk chocolate, mixed dairy product chocolate, sweet cocoa and vegetable fat coating, sweet chocolate and vegetable fat coating, milk chocolate and vegetable fat coating, vegetable fat based coating, pastels including white chocolate or coating made with cocoa butter or vegetable fat or a combination of these, nutritionally modified chocolate-like compositions (chocolates or coatings made with reduced calorie ingredients, such as sugarless chocolate, and fiber-containing chocolates) and low fat chocolates, unless specifically identified otherwise.

In the United States, chocolate is subject to a standard of identity established by the U.S. Food and Drug Administration (FDA) under the Federal Food, Drug and Cosmetic Act. Definitions and standards for the various types of chocolate are well established in the U.S. Non-standardized chocolates are those chocolates which have compositions that fall outside the specified ranges of the standardized chocolates.

The fat phase of the chocolate utilized in embodiments of the invention can include cocoa butter, milkfat, anhydrous milkfat, butteroil, and other vegetable fat and other modifications of these fats (CBR, CBE and CBS, referring to cocoa butter replacers, equivalents and substitutes) and synthetic fats or mixtures of cocoa butter with these fats. Some aspects of the present invention specify a chocolate material that contains at least 15% fat, as that level of fat is usually necessary to convey the desired mouth feel to the product.

As noted in U.S. Pat. No. 6,986,907 and PCT Publication No. WO 01/24640 (each of which is incorporated herein by references), it has been surprisingly found that chewing gums that do not include filler in the gum base produce gum cuds that, if improperly discarded, have reduced adhesion to environmental surfaces such as wood, concrete, fabric, carpet, metal and other such surfaces. Typically, gum bases include fillers. These fillers are inert organic powders such as calcium carbonate, magnesium carbonate, ground limestone, silica type compounds such as magnesium and aluminum silicate, clay, alumina, talc, titanium dioxide, calcium phosphate and combinations thereof. It has been found that by substantially eliminating the non-silica fillers from gum bases, the resultant chewing gum, when chewed, will produce gum cuds having reduced adhesion to environmental surfaces. It is now further believed that calcium carbonate or other non-silica materials fill in the gum base matrix of conventional ingredients and actually disrupts the matrix of conventional ingredients from holding together as a gum base matrix. It has also been discovered that vinyl polymers, such as polyvinyl acetate, frequently used in chewing gum base, also causes disruption of the gum base matrix. In some embodiments of the invention, the gum base has a reduced level of such gum base matrix disrupting materials, such that less than 45% of the base is such gum base matrix disrupting materials, and less than 10% of the base is filler. In other embodiments, the gum base is free or essentially free of non-silica fillers, and in some embodiments the base contains an effective amount of high molecular weight polyisobutylene.

It has been found that fillers and polyvinyl acetate (PVAc) can be reduced or eliminated from typical gum base formulations and replaced with other ingredients such as elastomers, gum base softeners or elastomer plasticizers. By adjusting the levels of elastomers, gum base softeners and elastomer plasticizers, this will compensate for any change in texture, taste, and overall quality of the product.

It has also been found that these same gum bases can be used to make chewing gum products containing chocolate that will have acceptable long term chew characteristics. The products include both chewing gum compositions that contain chocolate in a homogeneous mixture, as well as products that contain one or more pieces of chewing gum and chocolate in distinct regions, such as chewing gum pellets that are coated with chocolate, and optionally a hard shell coating over the chocolate, and filled chewing gum products containing a chocolate filling. Small bits of chewing gum could be mixed with chocolate and formed into a product. Fat-containing confections other than chocolate can be used with chewing gum in ways similar to all of the above.

A variety of different chewing gums can be created pursuant to the present invention. Such chewing gums can include sugar gums, sugarless gums, bubble gums, coated gums, and novelty gums. The chewing gum compositions can be formed in the shape of pellets (such as pillow and ball shapes), sticks, tabs, or chunks to name a few. A variety of different chewing gum formulations are possible. The chewing gum product may comprise a compressed chewing gum product. Also, chewing gum products can be made with gum base, about 0.1 to about 5% flavor, and chocolate, or other fat-containing confection, but with very little or no bulk sweeteners other than any that may be present in the chocolate or other fat-containing confection.

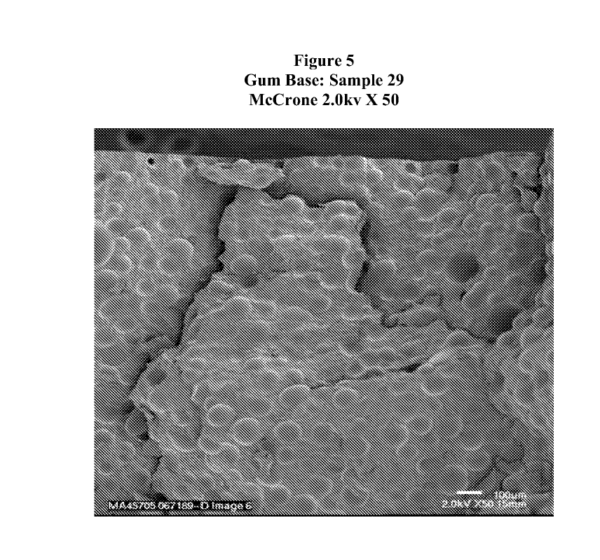

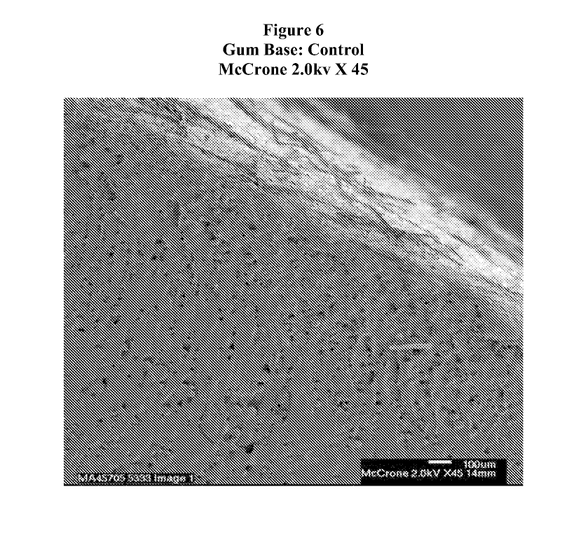

The chewing gum base used in most embodiments of the present invention has a reduced level of gum base matrix disrupting materials. At present, the primary gum base matrix disrupting materials that have been identified include fillers and polyvinyl acetate. It is believed that other vinyl polymers, such as polyvinyl laurate, vinyl acetate/vinyl laurate copolymers and vinyl acetate/vinyl stearate copolymers, will also disrupt the gum base matrix. (FIGS. 5 and 6, discussed in detail below, show a gum base matrix that has been disrupted.) These materials are thus limited in their use in the gum base, generally to less than 45% of the gum base, more preferably less than 40% of the gum base, and even to less than 25% of the gum base. Of course they can be eliminated all together in some embodiments.

Fillers are very disruptive of the gum base. Thus the filler should comprise less than 10% of the gum base. In the development of the invention in U.S. Pat. No. 6,986,907, it was thought that non-silica fillers were particularly undesirable in gum base being used where a removable gum cud was desirable. In some embodiments, the gum base is essentially free of non-silica filler. For purposes of the description of the present invention, being essentially free of non-silica filler means that the optional use of non-silica filler at levels of about 0% to about 1% of the chewing gum base is acceptable. In an embodiment of the present invention, the chewing gum base is free of non-silica filler.

The water-insoluble portion of the gum typically may contain many combinations of elastomers, elastomer plasticizers, gum base softeners (such as fats, oils and waxes), and other optional ingredients such as colorants and antioxidants. The variety of gum base ingredients typically used provides the ability to modify the chewing characteristics of gums made from the gum base.

High molecular weight polyisobutylene is used in the gum base of certain embodiments. As used herein, the term “high molecular weight polyisobutylene” means a polyisobutylene having a GPC average molecular weight of at least 200,000 Daltons. It is used as a replacement of up to 80% of butyl rubber in the formulation of the chewing gum base. High molecular weight polyisobutylene provides a cohesive property and is believed to reduce the cold flow property of a discarded chewing gum cud into environmental surfaces. The high molecular weight polyisobutylene also improves the softness of a chewing gum cud for improved organoleptic quality. The GPC average molecular weight of the high molecular weight polyisobutylene ranges from about 200,000 Daltons to about 600,000 Daltons. Preferably, the GPC average molecular weight of high molecular weight polyisobutylene is from about 360,000 Daltons to about 510,000 Daltons. The amount of high molecular weight polyisobutylene present in certain chewing gum bases ranges from about 5% to about 15% of the chewing gum base. Preferably, the amount of high molecular weight polyisobutylene is present in the amount of about 8% to about 9% of the chewing gum base. A high molecular weight polyisobutylene suitable for use in some embodiments of the present invention is OPPANOL B50, available from BASF in Ludwigshafen, Germany. This product is a polyisobutylene having a GPC average molecular weight of 360,000-510,000 Daltons, ground with 3% calcium carbonate. (Average molecular weights as used herein are based on molecular weight average measuring techniques commonly used in reporting average molecular weights for the polymers noted, such as GPC average molecular weight.)

Silica may optionally be added to the chewing gum base composition because silica has low oil absorption properties as compared to non-silica fillers. The amount of silica, when included, ranges from about 2% to about 15% of the chewing gum base. When included, the amount of silica may be about 5% of the chewing gum base, and may be an amorphous silica. These levels include any moisture, typically 2% to 4%, that may be present on commercially available silica.

Low molecular weight polyvinyl acetate is a plastic resin that should be limited in the chewing gum base composition, but may be used if the filler is very limited. The molecular weight of the PVAc, when used, may range from a GPC average of about 6,000 Daltons to a GPC average of about 40,000 Daltons. In addition, higher molecular weights can be used. The GPC average molecular weight of the low molecular weight PVAc preferably ranges from about 12,000 Daltons to about 16,000 Daltons. Medium molecular weights of 20,000 to 40,000 can be used, as well as higher MW PVAc to 90,000. The low molecular weight PVAc or other plastic resins, when included, may be used in amounts of about 5% to about 45% of the chewing gum base. In some embodiments, the amount of low molecular weight PVAc present is in the range from about 5% to about 30% of the chewing gum base, more preferably about 10% to about 25% In specific embodiments, the amount of low molecular weight PVAc is present at about 35% of the chewing gum base. One PVAc suitable for use in certain embodiments is Vinnapas B1,5 Spezial, available from Wacker in Burghausen, Germany, having a GPC average molecular weight of about 12,000 Daltons to about 16,000 Daltons.

The chewing gum base in certain embodiments may be used in amounts of about 18% to about 40% of the chewing gum composition when making stick and tab chewing gum products. In certain embodiments the chewing gum base can be used in amounts ranging from about 25% to about 50% of the chewing gum composition, or even as high as 80%, when the product is a shell filled with chocolate. Chewing gum compositions used to form centers for coated gum products may also have a high base content. In embodiments where a gum center has an extra high base content, the base may be 90% to 99% of the center.

Gum base softeners, also sometimes referred to as plasticizers, used in the gum base of certain embodiments may be waxes, fats, oils, and glycerol ester emulsifiers. It is believed that waxes and emulsifiers do not disrupt the base matrix, but have attributes that hold the base together.

Fats and oils are triglycerides, and specific triglycerides that may be used include medium chain triglycerides; triglycerides of fatty acids; non-hydrogenated, partially hydrogenated and fully hydrogenated cottonseed oil, soybean oil, palm oil, palm kernel oil, coconut oil, safflower oil, tallow oil and cocoa butter; unsaturated oils that contain, as one or more of their constituent groups, fatty acids of carbon chain length of from 6 to 18 monoglycerides. Other gum base softeners are natural waxes such as beeswax, carnauba wax, and candelilla wax, and petroleum waxes such as paraffin and microcrystalline waxes. Waxes may not be as effective in softening the gum base matrix as are fats and oils. Fats and oils are very lipophilic and can affect the gum base elastomers and elastomer plasticizers more than waxes.

More commonly, waxes used in gum base are microcrystalline waxes and paraffin waxes, and in some cases polyethylene waxes. These are all hydrocarbon waxes and are therefore hydrophobic. In most cases, waxes can be substituted for fats. However, there may be a limit to the quantity of wax that can be used in a gum base. In the prior art and conventional gum bases, waxes may be used in the gum base. Waxes aid in the solidification of gum bases and improving the shelf-life and texture. Wax crystals also improve the release of flavor. The smaller crystal size allows slower release of flavor since there is more hindrance of the flavor's escape from this wax versus a wax having larger crystal sizes.

Synthetic waxes are produced by means atypical of petroleum wax production and thus are not considered petroleum wax. These synthetic waxes may be used in accordance with some embodiments of the present invention, and may be included optionally in the gum base and gum.

The synthetic waxes may include waxes containing branched alkanes and copolymerized with monomers such as, but not limited to, polypropylene and polyethylene and Fischer-Tropsch type waxes. Polyethylene wax is not in the same category as polyethylene, a polymer of ethylene monomers. Rather, polyethylene wax is a synthetic wax containing alkane units of varying lengths having attached thereto ethylene monomers.

Wax-free gum bases are specifically contemplated for use with some embodiments of the present invention. In these embodiments, wax is omitted and may be compensated for by using increased levels of fats and oils as is known in the prior art. Low molecular weight waxes can increase the flow of the chewing gum cud into porous surfaces and are therefore undesirable in easily removable gum bases.

The approximate amount of gum base softener used in some embodiments is about 5% to about 30%, preferably about 5% to about 25% of the chewing gum base. In some embodiments, the gum base contains at least 10% fat.

Emulsifiers are not generally as effective as fats and oils at softening the base, but have other desirable properties. Emulsifiers are often mono and diglycerides, so have some hydrophilic and lipophilic properties (the effects of which are often referred to as hydrophilic-lipophilic balance, or HLB). Emulsifiers may include mono- and di-glycerides of fatty acids, glycerol mono- and distearate, acetylated monoglycerides, distilled mono-, and di-glycerides, polyglycerol esters, carbohydrate polyesters of fatty acids, triacetin, and lecithin. Preferred base formulas may not include any lecithin. Although both lecithin and glycerol monostearate are emulsifiers, glycerol monostearate is more beneficial in the gum base as one of the softeners. The approximate amount of emulsifier used in certain embodiments is about 1% to about 10% of the chewing gum base, sometimes about 2% to about 10% of the chewing gum base.

In addition to high molecular weight polyisobutylene and limited use of low molecular weight PVAc previously described, conventional elastomers may also be incorporated into the gum base. Elastomers provide the rubbery, cohesive nature to the gum which varies depending on this ingredient's chemical structure and how it is compounded with other ingredients. Other elastomers suitable for use in the gum base of some embodiments of the present invention include butadiene-styrene copolymers (SBR), isobutylene-isoprene copolymers (butyl rubber), polybutadiene, polyisoprene and low and medium molecular weight polyisobutylenes, or mixtures thereof. The approximate amount of elastomer used in certain embodiments is about 2% to about 40% of the chewing gum base. In other embodiments, the elastomers will make up about 2% to about 20% of the gum base.

Elastomer plasticizers vary the firmness of the gum base. Specific elastomer plasticizers used in some embodiments are synthetic plasticizers such as terpene resins derived from alpha-pinene, beta-pinene, and/or d-limonene and mixtures thereof. Natural rosin esters, also referred to as esters gums, including glycerol esters of partially hydrogenated rosins, glycerol esters of polymerized rosins, glycerol esters of partially dimerized rosins, glycerol esters of tall oil rosins, pentaerythritol esters of partially hydrogenated rosins, methyl esters of rosins, partially hydrogenated methyl esters of rosins, and pentaerythritol esters of rosins, may be included with some embodiments of the present invention.

The elastomer plasticizers used may be of one type or of combinations of more than one. Terpene resins are used as the elastomer plasticizers in some embodiments, as the ester gums have a tendency to increase adhesion to surfaces. However, ester gums generally may be used with SBR type elastomers, and terpene resins generally may be used with butyl rubber type elastomers. The approximate amount of elastomer plasticizer used in certain embodiments is about 10% to about 50%, preferably about 10% to about 40%, of the chewing gum base. The combination of elastomer and elastomer plasticizer of some embodiments will be at least 30% of the gum base.

Other optional ingredients such as antioxidants may also be used in the gum base. Antioxidants prolong shelf-life and storage of gum base, finished gum or their respective components, including fats and flavor oils. Antioxidants suitable for use in gum base or gum of certain embodiments include butylated hydroxyanisole (BHA), butylated hydroxytoluene (BHT), beta-carotenes, tocopherols, acidulants such as vitamin C, propyl gallate, and other synthetic and natural types, or mixtures thereof. The antioxidants used in certain gum bases are butylated hydroxyanisole (BHA), butylated hydroxytoluene (BHT), tocopherols, or mixtures thereof.

Non-silica fillers in the gum base are most typically calcium carbonate and talc. These materials are often used as processing aids or dusting agents mixed with commercially available elastomers. Also, these are used as processing aids when making the gum base. As a result, these fillers may comprise up to 5% of the gum base. It is preferred to limit the fillers in the gum base, either added as a processing aid or added from any other form, to less than 10%, more preferable less than 5%, and most preferably less than 1%. Any filler added to the chewing gum composition separate from the base will tend to behave like filler incorporated directly in the base when the gum is chewed. It is thus preferred to limit filler added to the gum composition from other sources.

Gum bases are typically prepared by adding an amount of the elastomer and elastomer plasticizer to a heated sigma blade mixer with a front to rear speed ratio of about 1:1 to about 2:1, the higher ratio typically being used for chewing gum base which requires more rigorous compounding of its elastomers.

Compounding typically begins to be effective once the ingredients have become homogenous. Anywhere from 15 minutes to 90 minutes may be the length of compounding time. The time of compounding is preferably from 20 minutes to about 60 minutes. The amount of added plasticizer depends on the level of elastomer present. If too much elastomer plasticizer is added, the initial mass becomes over plasticized and not homogeneous.

Continuous processes using mixing extruders may also be used to prepare the gum base. After the initial ingredients have massed homogeneously and been compounded for the time desired, the balances of the base ingredients are added in a sequential manner until a completely homogeneous molten mass is attained. Typically, any remainder of elastomer and elastomer plasticizer are added after the initial compounding time. The optional waxes and the oils are typically added after the elastomer and elastomer plasticizer. Then the mass is allowed to become homogeneous before discharging.

U.S. Pat. No. 6,238,710, herein incorporated by reference, claims a method for continuous chewing gum base manufacturing. The method entails compounding all ingredients in a single extruder. U.S. Pat. No. 6,086,925 discloses the manufacture of chewing gum base by adding a hard elastomer, a filler and a lubricating agent to a continuous mixer. U.S. Pat. No. 5,419,919 discloses continuous gum base manufacture using a paddle mixer by selectively feeding different ingredients at different locations on the mixer. U.S. Pat. No. 5,397,580 discloses continuous gum base manufacture wherein two continuous mixers are arranged in series and the blend from the first continuous mixer is continuously added to the second continuous mixer.

Typical base batch processing times may vary from about one to about three hours, specifically from about 1.5 to 2.5 hours, depending on the formulation. The final mass temperature when discharged may be between 50° C. and 130° C. and preferably between 70° C. and 120° C. The completed molten mass is emptied from the mixing kettle into coated or lined pans, extruded or cast into any desirable shape and allowed to cool and solidify. Those skilled in the art will recognize that many variations of the above described procedure may be followed.

In the alternative continuous process, ingredients are added continuously at various points along the length of the extruder. In this case, the transit time through the extruder would be substantially less than an hour.

The water-soluble portion of the chewing gum will contain chocolate, unless chocolate is used in a coated or filled product, in which case the chocolate is optional in the chewing gum composition. The chocolate used in certain embodiments comprises a sweetener, cocoa butter and chocolate liquor. In some embodiments the chocolate comprises at least 25% cocoa butter. The chocolate may further comprise a milk product, so as to be classified as milk chocolate. The approximate amount of chocolate used in certain embodiments is about 5% to about 50% or even 80% of the chewing gum composition.

The water-soluble portion of the chewing gum will also comprise sweetening and bulking agents, which may be a single ingredient, as sweeteners often function also as bulking agents in the gum. The sweetening/bulking agents generally comprise from approximately 5% to about 90%, preferably from about 10% to about 50% or even 60% of the finished gum when the gum is not used to make a coated product, and about 10% to about 60% when the gum product is coated. In the very high base gum centers, there will be 0% to about 5% bulk sweeteners. If no bulk sweeteners are used, about 0.1% to about 2% high-intensity sweeteners are usually included.

Sugar sweeteners generally include saccharide-containing components commonly known in the chewing gum art which comprise, but are not limited to, sucrose, dextrose, maltose, dextrin, dried invert sugar, fructose, levulose, galactose, corn syrup solids and the like, alone or in any combination.

Certain embodiments can also use sugarless sweeteners. Generally, sugarless sweeteners include components with sweetening characteristics but which are devoid of the commonly known sugars and comprise, but are not limited to, sugar alcohols such as sorbitol, mannitol, erythritol, isomalt, xylitol, hydrogenated starch hydrolysates, maltitol and the like, alone or in any combination.

High-intensity artificial sweeteners can also be used, alone or in combination, with the above. Such sweeteners include, but are not limited to, sucralose, aspartame, APM derivatives such as neotame, salts of acesulfame, alitame, saccharin and its salts, cyclamic acid and its salts, glycyrrhizinate, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extension may be used to achieve the desired release characteristics.

The water-soluble portion of the chewing gum may also include softeners, flavoring agents and combinations thereof. Softeners are added to the chewing gum in order to optimize the chewability and mouth feel of the gum. Softeners typically constitute from approximately 0.5% to about 25% of the chewing gum. Softeners contemplated for use in the gum include glycerin, lecithin and combinations thereof. Further, aqueous sweetener solutions such as those containing sorbitol, hydrogenated starch hydrolysates, corn syrup and combinations thereof may be used as softeners and bulking agents in gum. Sugar-free formulations are also typical.

Flavorants and colorants impart characteristics or remove or mask undesired characteristics. A flavoring agent may be present in the chewing gum in an amount within the range of from approximately 0.1% to about 10%, and preferably from approximately 0.5% to about 3% of the gum. In the very high base gum centers, there will be 0.1% to about 5% flavor. The flavoring agents may comprise essential oils, synthetic flavors, or mixtures thereof including, but not limited to, oils derived from plants and fruits such as citrus oils, fruit essences, peppermint oil, spearmint oil, close oil, oil of wintergreen, anise and the like. Artificial flavoring components are also contemplated for use with some embodiments of the present invention. Those skilled in the art will recognize that natural and artificial flavoring agents may be combined in any sensory acceptable blend. All such flavors and flavor blends are contemplated for use in gums of the present invention. Particularly preferred are flavors that compliment chocolate flavor, such as chocolate-mint and chocolate-fruit flavors, particularly chocolate cherry and chocolate strawberry. Other complimentary flavors, such as vanilla, caramel and cream flavors, can be added. In addition to the chocolate, chocolate flavor may be included, provided by cocoa powder or artificial chocolate flavor.

Chewing gum compositions of some embodiments of the present invention may also include other forms of flavors, such as spray dried flavor or flavor beads, as a partial or complete replacement of liquid flavor. This reduces the plasticizing or tackifying quality that liquid flavors provide. The amount of liquid flavor used would reduce to about 0.4% to about 2% of the chewing gum composition. The loading of the spray dried flavor used in certain embodiments can be approximately 20% active. The amount of spray dried flavor may be used up to about 2% of the chewing gum composition. In some embodiments spray dried flavor is used in amounts ranging from about 0.2% to about 2% of the chewing gum composition, and preferably at about 1% of the chewing gum composition.

Optional ingredients such as colors, emulsifier and pharmaceutical agents, coolants, oral sensates, active agents, antimicrobials, tooth whitening agents, medicaments, breath freshening agents, nutritional supplements, wellness agents, weight loss agents, and combinations thereof may be added to the chewing gum compositions or elsewhere in the products of some embodiments of the present invention. Colorants may typically include FD&C type lakes, plant extracts, fruit and vegetable extracts and titanium dioxide.

In general, chewing gum is manufactured by sequentially adding the various chewing gum ingredients to a commercially available mixer known in the art. After the initial ingredients have been thoroughly mixed, the gum mass is discharged from the mixer and shaped into the desired form such as by rolling into sheets and cutting into sticks or tabs, extruded into chunks, or casting into pellets having a pillow or ball shape. Alternatively, various chewing gum ingredients can be blended together and then compressed together to form a compressed chewing gum product.

For chewing gum products made in a conventional manner, the ingredients are mixed by first melting the gum base and adding it to the running mixer. The base may also be melted in the mixer itself. Color or emulsifier may also be added at this time. A softener such as glycerin may also be added at this time, along with syrup and a portion of the bulking agent/sweetener. Further portions of the bulking agent/sweetener may then be added to the mixer. A flavoring agent is typically added with the final portion of the bulking agent/sweetener. A high-intensity sweetener may be added after the final portion of bulking agent and flavor have been added. A molten chocolate may be added at any time during the gum mixing process, but preferably after the base, initial bulking agent portion and syrup have been mixed together, and before the final bulking agent/sweetener and flavor is added. If solid chocolate is used, it should be mixed early with the base and first portion of the bulk sweetener.

Although generally the gum base is melted before adding to the mixture, in certain embodiments, the gum base is not melted prior to adding it to the mixer.

The entire mixing procedure typically takes from five to fifteen minutes, longer mixing times may sometimes be required. Those skilled in the art will recognize that many variations of the above described procedure may be followed. Again, one specifically contemplated embodiment is the use of an extruding mixer for continuous processing. In such a process, ingredients are added continuously at various points along the length of the extruder while homogeneously mixed gum continuously issues from the discharge end of the extruder. U.S. Pat. No. 6,017,565, herein incorporated by reference, discloses a continuous manufacture process which automatically and continuously feeds ingredients into an apparatus, mixes, and discharges the desired end product. The end product is automatically dusted, rolled scored and wrapped. U.S. Pat. No. 5,543,160 discloses a manufacturing process using high efficiency continuous mixing which does not require separate manufacture of gum base.

After mixing, the chewing gum is formed into a final product shape using well known techniques which may employ extrusion, rolling, sheeting, scoring or forming. The final product shape may be stick, tabs, chunks, pellets (such as pillows or balls) or any other desired shape.

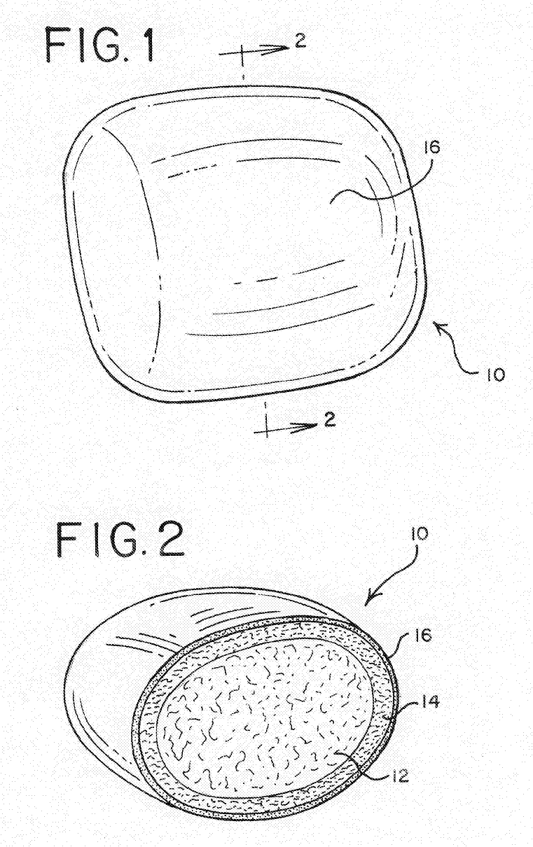

Tab, stick and chuck forms can be coated with chocolate using methods such as enrobing, depositing and moulding. Pillow and ball forms, among others, are typically pan coated. Thus, in one embodiment, a chocolate containing chewing gum composition is formed into a piece and the piece is coated with a hard shell coating. In another embodiment, a chewing gum composition (perhaps using the base of the present invention and optionally chocolate) is made into pieces and coated with chocolate. The chocolate coated pieces may further be coated with a hard shell coating. FIGS. 1 and 2 disclose such a product 10, having a chewing gum center 12, a coating of chocolate 14, and a hard shell coating 16.

Conventional panning procedures generally coat with sucrose, but advances in panning have allowed the use of other carbohydrate materials to be used in the place of sucrose. Some of these components include, but are not limited to, dextrose, maltose, sorbitol, maltitol, xylitol, hydrogenated isomaltulose erythritol, lactitol and other new polyols, or a combination thereof. These materials may be blended with panning modifiers including, but not limited to, gum arabic, maltodextrins, corn syrup, gelatin, cellulose type materials like carboxymethyl cellulose or hydroxymethyl cellulose, starch and modified starches, vegetable gums like alginates, locust bean gum, guar gum and gum tragacanth, insoluble carbonates like calcium carbonate or magnesium carbonate, and talc. Anti-tack agents may also be added as panning modifiers, which allow the use of a variety of carbohydrates and sugar alcohols to be used in the development of new panned or coated gum products. Flavors may also be added with the polyol or sugar coating to yield unique product characteristics.

If the chewing gum composition is in a piece form and a chocolate coating is to be applied, a sealing layer or coating of gum arabic should be applied before the chocolate coating. In addition, if a sugar or polyol coating is applied after the chocolate coating, another sealing layer of gum arabic may be applied after the chocolate coating. The piece is preferably coated with a 60% solution of an 80/20 mixture of sugar/gum arabic to form the binder layer. One or two coats of syrup are applied to the pieces in a conventional coating pan and dried with a 80/20 dry sugar/gum arabic mixture. If a sugarless product is desired, sorbitol may be substituted for the sugar in both the solution and powder. This binder layer seals the piece to prevent migration of components between the piece and the coating layers, and aids in the adherence of the chocolate coating layer. The binder may be selected from the group consisting of natural gums and their hydrolysates, hydrocolloids, modified starches, starch derivatives, cellulose derivatives, cocoa powder and mixtures thereof. Modified starches include dextrins, maltodextrins, and corn syrup solids. Starch derivatives include materials such as hydroxypropyl starch. Cellulose derivatives include hydroxypropyl cellulose and hydroxypropyl methyl cellulose. Fiber materials may also be used, such as psyllium fiber, fruit fiber, and derivatives including pectin. The gums may include seaweed gums and derivatives, including carrageenan, agar, and alginates, cellulose and derivatives, cereal gum fibers, including corn, wheat, oat, rice, barley, and soy, fructooligosaccharides and it derivatives, seed gums including guar and locust bean, tree gums including karaya, tragacanth, and acacia, xanthan gum, vegetable fiber including pea and legumes and potato fiber.

The chocolate coating may be applied by any suitable procedure, such as pan coating, enrobing, moulding and depositing. Especially for tabs and sticks, an enrobing process may be used. In an enrobing process, a bottomer is first used to coat the bottom of the gum piece. The gum piece is conveyed to a section of the equipment where a belt submerged in chocolate is used to further convey the pieces, with the pieces thus having their bottoms covered with chocolate. Thereafter the pieces are conveyed through a curtain of falling chocolate to cover the remaining sides (including the top) of the gum piece. Preferably tempered chocolate is used in the enrobing process, to create a finished product with a desirable appearance and texture.

The coating typically comprises about 10% to about 75% of the product. The level of chocolate coating may be about 20% to about 50% of the final product, and, when used, the hard shell sugar or polyol coating layer may be about 10% to about 50% of the final product, and specifically about 20% to about 40%. Flavors may be included as part of the coating. If a chocolate coating is applied, these flavors may be mixed with the chocolate when it is applied, or may be applied as part of the hard shell coating optionally applied over the chocolate. As noted above, these flavors may be chosen to complement the chocolate flavor of the product.

Filled chewing gum products of some embodiments of the present invention are made by conventional techniques that are capable of creating a shell of chewing gum material filled with a filling comprising chocolate. An example technique is disclosed in U.S. Pat. No. 3,806,290, which is hereby incorporated by reference. In some embodiments the chocolate filling fill will comprise between about 5% and about 20% of the total product.

By way of example, and not limitation, examples of the present invention are set forth below.

Gum Base Examples

The following gum base formulations have been made on lab scale or production scale:

| | Example 1 | Example 2 | Example 3 | Example 4 |
|---|---|---|---|---|
| High MW | 8.15 | 9.19 | 8.56 | 9.02 |
| Polyisobutylene | | | | |
| Calcium carbonate* | 0.32 | 0.61 | 0.56 | 0.42 |
| Terpene Resin | 28.96 | 32.66 | 30.30 | 30.33 |
| Glycerol Monostearate | 5.54 | 6.25 | 5.83 | 5.83 |
| Low MW Polyvinyl | 33.87 | 38.20 | 35.53 | 35.56 |
| acetate | | | | |
| Partial Hydrogenated | 6.74 | — | — | — |
| Cottonseed Oil | | | | |
| Hydrogenated | 9.51 | 10.73 | 9.98 | 9.96 |
| Cottonseed Oil | | | | |
| Hydrogenated Palm Oil | — | — | 7.05 | 6.68 |
| Isobutylene-isoprene | 2.04 | 2.30 | 2.13 | 2.14 |
| copolymer | | | | |
| Amorphous silica | 4.74 | — | — | — |
| Water | 0.13 | — | — | — |
| BHA | 0.06 | 0.06 | 0.06 | 0.06 |
| | 100.0 | 100.0 | 100.0 | 100.0 |

*Calcium carbonate is at a low level and results from the dusting agent and filler used in processing of the elastomers such as polyisobutylene and isobutylene-isoprene copolymer. The high molecular weight polyisobutylene used in these examples was the OPPANOL B50 material discussed above, with 3% calcium carbonate. The low molecular weight polyvinyl acetate was Vinnapas B1, 5 Spezial discussed above.

In Example 1 above, silica was evaluated as filler in place of calcium carbonate filler. Example 2 was made to give a reduced total fat level compared to Examples 3 and 4.

In all of these examples, high molecular weight polyisobutylene is used as an elastomer along with a low level of isobutylene-isoprene copolymer. The level of elastomer and terpene resins are higher than in conventional calcium carbonate filled base, as a result of the removal of the filler. The level of hydrogenated oils, fats and emulsifier are at normal to slightly higher levels compared to conventional gum bases.

Gum Examples

The following chewing gum examples had the following gum formulas:

| | Example 5 | Example 6 |
|---|---|---|
| Gum base of Example 1 | 30.0 | 30.0 |
| Sugar | 46.0 | 40.5 |
| Evaporated corn syrup* | 13.0 | 13.0 |
| Artificial chocolate flavor | 1.0 | 1.0 |
| Chocolate | 10.0 | 10.0 |
| Glycerin | — | 0.5 |
| Low fat cocoa powder | — | 5.0 |

*The corn syrup was evaporated to 85% solids

The chocolate used in Examples 5 and 6 was Hershey Milk Chocolate candy bars. The gum formula of Example 5 had a very firm initial texture, which could be improved by the addition of glycerin. Further chewing showed the gum held together and did not become very soft and did not dissolve in the mouth due to the presence of cocoa butter in the chocolate.

For Example 6, glycerin was added and additional low fat cocoa powder was added to give a more chocolate taste. The texture was still firm initially, but the overall texture was good and did not become very soft with extended chewing.

Additional examples were made using the gum base formula of Example 3:

| | Example 7 | Example 8 | Example 9 |
|---|---|---|---|
| Gum base of Example 3 | 30.0 | 28.0 | 28.0 |
| Sugar | 40.5 | 42.3 | 42.9 |
| Evaporated corn syrup* | 13.0 | 13.0 | 13.0 |
| Chocolate | 10.0 | 10.0 | 15.0 |
| Glycerin | 0.5 | 0.5 | — |
| Artificial chocolate | 1.0 | 1.0 | 1.0 |
| flavor | | | |
| Low Fat cocoa powder | 5.0 | 5.0 | — |
| Encapsulated sucralose | — | 0.2 | — |
| Sucralose | — | — | 0.1 |

*The corn syrup was evaporated to 85% solids

The chocolate used in Examples 7-9 was a milk chocolate. These formulas confirm that higher levels of chocolate can be used with no filler gum base to make acceptable chewing gum products.

Additional gum formulas were made to determine if a gum can be made that would support the use of a chocolate coating over the gum. The following sugarless gum formulas were made.

| | Example 10 | Example 11 | Example 12 |
|---|---|---|---|
| Gum base of Example 4 | 25.0 | 15.0 | — |
| Gum base of Example 2 | 5.0 | 15.0 | 30.0 |
| Sorbitol | 62.4 | 59.4 | 59.4 |
| Glycerin | 5.0 | 8.0 | 8.0 |
| Peppermint flavor | 1.9 | 1.9 | 1.9 |
| Encapsulated sweeteners | 0.5 | 0.5 | 0.5 |
| Acesulfame K | 0.2 | 0.2 | 0.2 |

These formulas were formed into gum pellets and hand dipped into melted chocolate from Blommer Chocolate Co., referred to as Wisconsin Milk Chocolate and has a composition of: 57% sugar, 20% cocoa butter, 12% whole milk, 10% chocolate liquor, less than 0.5 lecithin, and less than 0.1% vanillin. After cooling to solidify the chocolate, it was estimated that the chocolate accounted for about 50% of the total product. The chocolate coated samples were chewed and it was determined that the high level of chocolate caused the gums of Examples 10 and 11 to become softer than desired. However, the products still held together during the later stages of chewing. Example 12, even with 50% chocolate coating, was not too soft and had a good texture throughout.

Additional gum samples were made to modify the texture of the finished gum using the gum base of Example 2. These formulas were:

| | Example 13 | Example 14 | Example 15 |
|---|---|---|---|
| Gum base of Example 2 | 30.0 | 30.0 | 30.0 |
| Sorbitol | 63.0 | 64.2 | 63.8 |
| Glycerin | 2.4 | 2.4 | 2.4 |
| Peppermint flavor | 1.9 | 1.9 | 1.9 |
| Encapsulated sweeteners | 0.5 | 0.5 | 0.5 |
| Acesulfame K | 0.2 | 0.2 | 0.2 |
| Triacetin | 2.0 | 0.8 | 1.2 |

These formulas were also formed into gum pellets and hand dipped into melted Wisconsin Milk Chocolate from Blommer Chocolate Co. After cooling to solidify the chocolate, the samples were chewed. (The level of chocolate coating was not measured, but was probably less than 50%.) Example 15 gave the best texture, whereas Example 13 was slightly soft and Example 14 was slightly firm.

Similarly, more sugarless gum examples were made using gum base of Example 4. The formulas are shown below.

| | Example 16 | Example 17 | Example 18 |
|---|---|---|---|
| Gum base of Example 4 | 30.0 | 30.0 | 30.0 |
| Sorbitol | 64.2 | 63.6 | 62.8 |
| Glycerin | 2.4 | 2.4 | 2.4 |
| Peppermint flavor | 1.9 | 1.9 | 1.9 |
| Encapsulated sweeteners | 0.5 | 0.5 | 0.5 |
| Acesulfame K | 0.2 | 0.2 | 0.2 |
| Triacetin | 0.8 | 1.4 | 1.2 |
| Water | — | — | 1.0 |

The chewing gum examples were coated by hand dipping in melted Wisconsin Milk Chocolate from Blommer Chocolate Co. After cooling to solidify the chocolate, the samples were chewed. Example 16 was firm initially and had a good texture throughout. Example 18 was firm initially but became very soft later in the chew. Example 17 was slightly firm initially, and did not get too soft at the back end of the chew.

Additional examples were made with increased glycerin and/or increased gum base levels of both sugarless or sugar gum to improve texture before chocolate coating. These are:

| | Example | Example | Example | Example |
|---|---|---|---|---|
| | 19 | 20 | 21 | 22 |
| Gum base of Example 4 | 30.0 | 30.0 | 30.0 | 33.0 |
| Sorbitol | 64.8 | — | 61.8 | — |
| Sugar | — | 65.4 | — | 62.4 |
| Glycerin | 3.0 | 2.4 | 3.0 | 2.4 |
| Peppermint flavor | 1.5 | 1.5 | 1.5 | 1.5 |
| Encapsulated sweeteners | 0.5 | 0.5 | 0.5 | 0.5 |
| Acesulfame K | 0.2 | 0.2 | 0.2 | 0.2 |

The chewing gum examples were coated by hand dipping in melted Wisconsin Milk Chocolate from Blommer Chocolate Co. After cooling to solidify the chocolate, the samples were chewed. Examples 19 and 20 were firm initially, and became soft in the later stages of chewing. Although soft, the gum did not fall apart or become too soft in later stages of chewing. Examples 21 and 22 had good texture in the initial stages of chewing and the later stages of chewing.

### Example 23

The chewing gum composition formula of Example 22 was used to make additional pieces to prepare laboratory size coating batches to prepare a chocolate panned product. Standard pillow shaped gum pieces were made, which weighed 0.97 grams per piece. The pieces were coated with a 40% gum arabic solution, followed by gum arabic powder, to seal the pieces before chocolate coating. Wisconsin Milk Chocolate from Blommer Chocolate Co. was melted in a table top temperer set at 86° F. and transferred to a beaker in a water bath set at 90° F. The melted chocolate was drizzled onto the bed of pellets in a coating pan and allowed to cool during coating to solidify the chocolate. About one half gram of chocolate was added per piece for a chocolate coating weight of 1.52 grams. These pieces were then coated with a 70 Brix sugar syrup and modified starch mixture (95:5 sugar:starch ratio) to a weight of 1.74 grams. Peppermint flavor was also added to the sugar coating at about 0.1% of the total piece weight at two coating intervals. A finished coating of 60 Brix with a lower level of sugar and modified starch (95:5 sugar:starch ratio) was used for additional coatings to a piece weight of 1.93 grams. The chocolate coated gum with a hard candy shell on the outside was chewed and showed good initial texture and good mint/chocolate flavor.

### Example 24

Another sample of gum was prepared using a much higher level of gum base to give a smaller gum center with sufficient cud size. The following formula was made:

| | Example 24 |
|---|---|
| Gum base of Example 4 | 67.9% |
| Sugar | 27.2% |
| Glycerin | 0.9% |
| Encapsulated sweeteners | 0.8% |
| Peppermint flavor | 3.2% |

The gum was formed into square pellets at 0.51 grams per piece. A 600 gram quantity of gum centers were placed in a coating pan and precoated with 9 grams of a 20/60/60 syrup mixture of gum arabic/sugar/water and dried to isolate the gum center from the chocolate coating layer and to prevent water migration from the gum into the chocolate.

Wisconsin Milk Chocolate from Blommer Chocolate Co. was heated in a microwave and placed in the table top temperer set at 110° F. Three applications of about 5 grams of chocolate were applied to the gum centers. After this, heavier applications were made until a target weight of 1.02 grams was achieved or a 50% coating. Intermittently, heat was applied with a hot air/heat gun for several seconds at about 140° F. to smooth out the chocolate coating. After this, a sugar/modified starch/water mixture at 70 Brix (95:5 sugar:starch ratio) was used to continue coating, followed by a 60 Brix solution of sugar/modified starch/water (95:5 sugar:starch ratio) mixture to a coating weight of 1.54 grams. Two of the 60 Brix solution applications had peppermint flavor mixed in with them, providing a peppermint flavor level of 0.14% of the total product weight. Sensory evaluation of the mint/chocolate coated gum showed the gum to have firm texture initially and a firm texture throughout the chew.

### Samples 25-43 and Examples 44-49

In the following Samples 25-42, calcium carbonate is at a low level and results from the dusting agent and filler used in processing of the elastomers such as polyisobutylene and isobutylene-isoprene copolymer. The polyisobutylene used in these Samples was OPPANOL B50 material discussed above, with 3% calcium carbonate, except in the Control, which used a low molecular weight polyisobutylene. The polyvinyl acetate was Vinnapas B1,5 Spezial discussed above.

### Base Compositions

| | | Sample | Sample | Sample | Sample |
|---|---|---|---|---|---|
| | Control | 25 | 26 | 27 | 28 |
| Isobutylene-Isoprene | 10.0 | 2.1 | 31.5 | 1.5 | 1.5 |
| Copolymer | | | | | |
| Polyisobutylene | 2.2 | 8.8 | 6.2 | 6.2 | 36.2 |
| Calcium Carbonate | 16.2 | 0.4 | 0.3 | 30.3 | 0.3 |
| Terpene Resins | 24.9 | 29.7 | 20.8 | 20.8 | 20.8 |
| Polyvinyl acetate | 25.9 | 34.9 | 24.4 | 24.4 | 24.4 |
| Hydrogenated | 3.0 | 9.8 | 6.8 | 6.8 | 6.8 |
| Cottonseed Oil | | | | | |
| Hydrogenated Palm | — | 6.6 | 4.6 | 4.6 | 4.6 |
| Oil | | | | | |
| Microcrystalline wax | 11.0 | — | — | — | — |
| Low melting Paraffin | 0.9 | — | — | — | — |
| wax | | | | | |
| Glycerol Monostearate | 4.5 | 5.7 | 4.0 | 4.0 | 4.0 |
| Lecithin | 1.4 | — | — | — | — |
| Talc | — | 2.0 | 1.4 | 1.4 | 1.4 |
| Antioxidants | <0.1 | <0.1 | <0.1 | <0.1 | <0.1 |
| Total Elastomers | 37.1 | 40.6 | 58.5 | 28.5 | 58.5 |
| and Elastomer | | | | | |
| Plasticizers | | | | | |
| Total filler and PVAc | 42.1 | 37.3 | 26.1 | 56.1 | 26.1 |
| Ratio | 0.88 | 1.09 | 2.24 | 0.51 | 2.24 |
| % Passing | 50 | 45 | 65 | 40 | 70 |
| | Sample | Sample | Sample | Sample | Sample |
| | 29 | 30 | 31 | 32 | 33 |
| Isobutylene-Isoprene | 1.7 | 1.7 | 1.7 | 1.5 | — |
| Copolymer | | | | | |
| Polyisobutylene | 7.1 | 7.1 | 7.1 | 6.2 | 9.0 |
| Calcium Carbonate | 0.3 | 0.3 | 0.3 | 0.3 | 0.4 |
| Terpene Resins | 23.8 | 43.8 | 23.8 | 20.8 | 30.4 |
| Polyvinyl acetate | 47.9 | 27.9 | 27.9 | 24.4 | 35.6 |
| Hydrogenated | 7.8 | 7.8 | 16.7 | 6.8 | 10.0 |
| Cottonseed Oil | | | | | |
| Hydrogenated Palm | 5.2 | 5.2 | 11.2 | 4.6 | 6.7 |
| Oil | | | | | |
| Glycerol Monostearate | 4.6 | 4.6 | 9.8 | 4.0 | 5.8 |
| Talc | 1.6 | 1.6 | 1.6 | 31.4 | 2.0 |
| Antioxidants | <0.1 | <0.1 | <0.1 | <0.1 | <0.1 |
| Total Elastomers | 32.6 | 52.6 | 32.6 | 28.5 | 39.4 |
| and Elastomer | | | | | |
| Plasticizers | | | | | |
| Total filler and PVAc | 49.8 | 29.8 | 29.8 | 56.1 | 38.0 |
| Ratio | 0.65 | 1.77 | 1.09 | 0.51 | 1.03 |
| % Passing | 50 | 50 | 45 | 40 | 40 |
| | Sample | Sample | Sample | Sample | Sample |
| | 34 | 35 | 36 | 37 | 38 |
| Isobutylene-Isoprene | 2.3 | 3.1 | 2.9 | 2.6 | 2.1 |
| Copolymer | | | | | |
| Polyisobutylene | 2.1 | 12.9 | 12.2 | 11.0 | 9.0 |
| Calcium Carbonate | 0.4 | 0.6 | 0.6 | 0.5 | 0.4 |
| Terpene Resins | 31.9 | 43.4 | 2.9 | 37.0 | 30.3 |
| Polyvinyl acetate | 37.4 | 5.0 | 48.1 | 43.4 | 35.6 |
| Hydrogenated | 10.5 | 14.2 | 13.5 | 1.3 | 10.0 |
| Cottonseed Oil | | | | | |
| Hydrogenated Palm | 7.0 | 9.6 | 9.1 | 0.9 | 6.7 |
| Oil | | | | | |
| Glycerol Monostearate | 6.2 | 8.3 | 7.9 | 0.8 | 5.9 |
| Talc | 2.2 | 2.9 | 2.8 | 2.5 | — |
| Antioxidants | <0.1 | <0.1 | <0.1 | <0.1 | <0.1 |
| Total Elastomers | 36.3 | 59.4 | 18.0 | 50.6 | 41.4 |
| and Elastomer | | | | | |
| Plasticizers | | | | | |
| Total filler and PVAc | 40.0 | 8.5 | 51.5 | 46.4 | 36.0 |
| Ratio | 0.91 | 6.99 | 0.35 | 1.09 | 1.15 |
| % Passing | 40 | 55 | 30 | 45 | 45 |
| | Sample | Sample | Sample | Sample | Sample |
| | 39 | 40 | 41 | 42 | 43 |
| Isobutylene-Isoprene | 11.0 | 2.1* | — | 2.1 | 3.4 |
| Copolymer | | | | | |
| Polyisobutylene | — | 8.9 | 11.0 | 8.9 | 13.7 |
| Calcium Carbonate | 0.4 | 0.4 | 0.4 | 0.4 | 0.4 |
| Terpene Resins | 29.7 | 29.7 | 29.7 | 29.7** | 47.4 |
| Polyvinyl acetate | 34.9 | 34.9 | 34.9 | 34.9 | — |
| Hydrogenated | 9.8 | 9.8 | 9.8 | 9.8 | 15.6 |
| Cottonseed Oil | | | | | |
| Hydrogenated Palm | 6.5 | 6.5 | 6.5 | 6.5 | 10.4 |
| Oil | | | | | |
| Glycerol Monostearate | 5.7 | 5.7 | 5.7 | 5.7 | 9.1 |
| Talc | 2.0 | 2.0 | 2.0 | 2.0 | — |
| Antioxidants | <0.1 | <0.1 | <0.1 | <0.1 | <0.1 |
| Total Elastomers | 40.7 | 40.7 | 40.7 | 40.7 | 64.5 |
| and Elastomer | | | | | |
| Plasticizers | | | | | |
| Total filler and PVAc | 37.3 | 37.3 | 37.3 | 37.3 | 0.4 |
| Ratio | 1.15 | 1.15 | 1.15 | 1.15 | 161.25 |
| % Passing | 50 | 50 | 50 | 50 | |

*SBR replaces butyl rubber
**Glycerol ester of Partially Hydrogenated gum rosin replaces terpene resins

The “% Passing” in the above tables for Samples 25-42 refers to the results of tests that were carried out. Finished gum base was smeared in a mixer at 50° C. for 2-3 minutes and Barry Callebaut Dark Chocolate was added and mixed for approximately 1-2 minutes at increasing percentages (mixing times varied between samples in order to assure the final mixture was homogenous). Samples were removed and held at room temperature for 24 hours. Samples were evaluated by chewing based on a 0.6 gram quantity of gum base with the additional chocolate. Samples were chewed for 10 minutes unless the sample fell apart prior to 10 minutes. Samples were rated as pass or fail. The highest level of chocolate to gum base that did not result in the gum base loosing its cohesiveness within the 10 minutes of chewing was the % Passing. For example, a gum base/chocolate mixture of 0.6 grams of base and 0.6 grams of chocolate was chewed and did not loss its cohesiveness, but a gum base/chocolate mixture of 0.6 grams of base and 0.66 grams of chocolate fell apart in 10 minutes, then % Passing would be 0.6/1.2=50%.

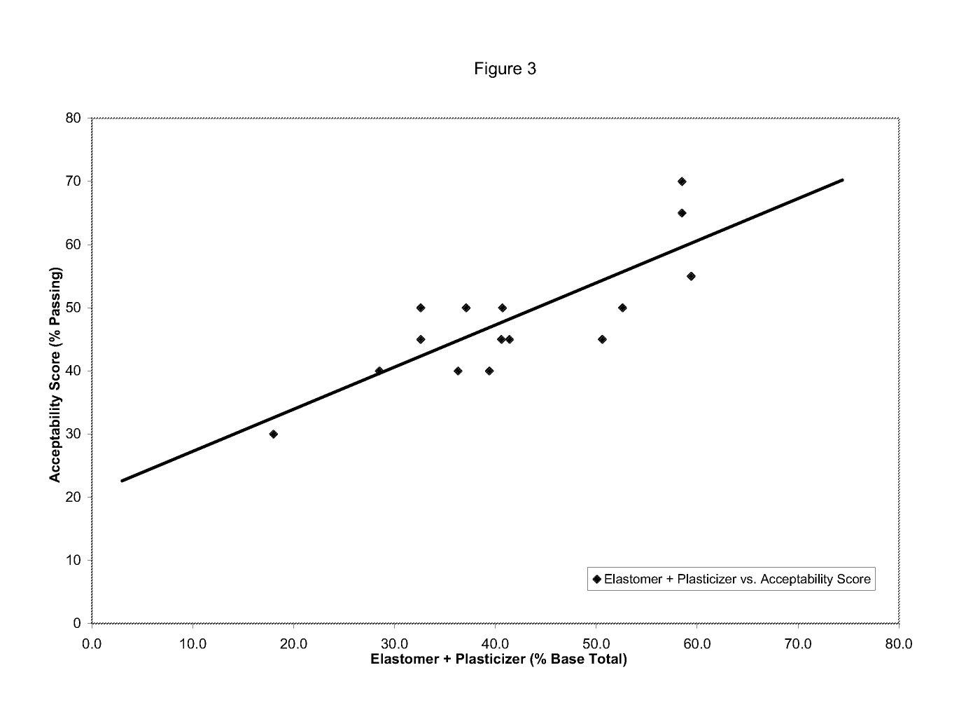

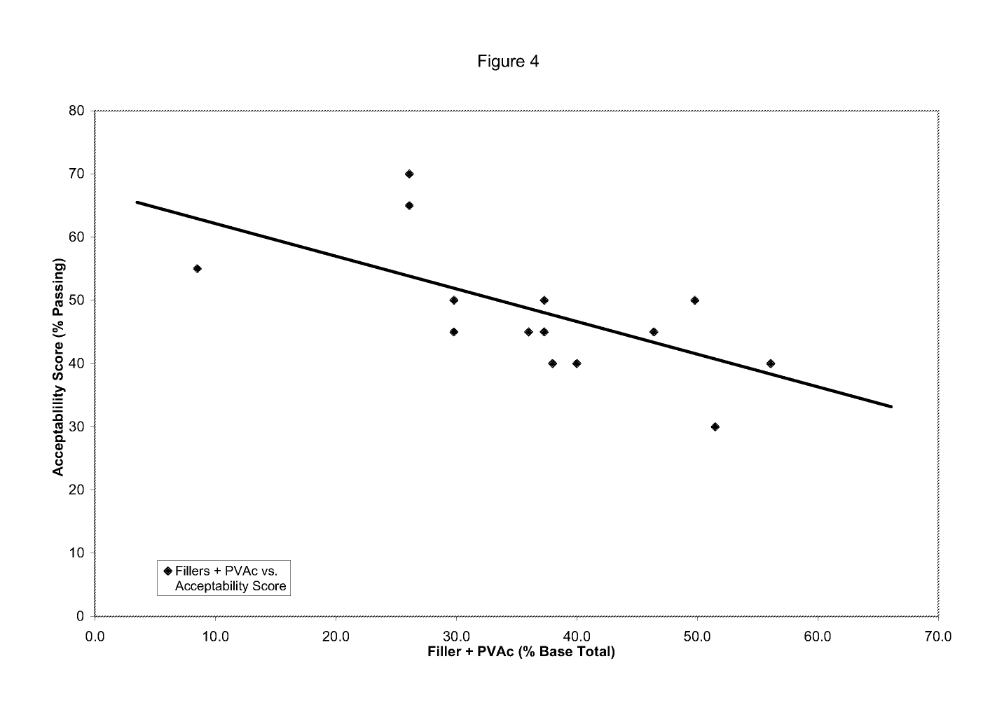

FIG. 3 graphically shows how the levels of elastomer+elastomer plasticizer affects the amount of chocolate that can be included with the sample bases and still produce an acceptable chewing experience. As seen in FIG. 3, as the level of elastomer plus elastomer plasticizer increases, the amount of chocolate that could be mixed with the base, without the base disintegrating during the chewing experiment, increased. On the other hand, FIG. 4 shows the affect of the level of filler and PVAc in the gum base. As the level of these gum base matrix disrupting ingredients increases, the amount of chocolate that could be mixed with the base, without the base disintegrating during the chewing experiment, decreased. The chewing gum composition will preferably have a ratio of the combined total of any elastomer plus any elastomer plasticizers in the gum base to the combined total of any PVAc plus any filler in the gum base is at least 1:1, more preferably a ratio of at least 2:1, and most preferably the ratio of the combined total of any elastomer plus any elastomer plasticizers in the gum base to the combined total of any PVAc plus any filler in the gum base will be at least 3:1. One embodiment of the invention is a chewing gum composition made with a gum base that contains less than about 1% PVAc and less than about 5% filler.

FIGS. 5-7 show scanning electron microscope (SEM) images for three of the above gum bases: the Control, Sample No. 29 and Sample No. 43. These images were obtained by McCrone Associates using the following procedure. McCrone Associates examined the three gum base samples by SEM. Sample Nos. 29 and 43 broke clean when snapped in half, whereas the Control Sample did not. The snapped samples were cut around to an appropriate size for SEM sample introduction and a sample of the Control gum base was cut out with a scalpel on all sides. Samples of each were also submerged in liquid nitrogen to freeze fracture and possibly obtain a cleaner cross-section. Each sample cracked throughout laterally and transversely and crumbled when fractured. Both types of sections were mounted on a SEM stub adhered with adhesive carbon tape and carbon paint. Then each stub was coated with 12-15 nm of gold-palladium (Au/Pd) for conductivity. No layer structure was found in any of the samples. Sample No. 29 had many bubbled features throughout in both sample preparations not seen in the other samples. The Control Sample appeared somewhat smeared in the room temperature sample preparation but the liquid nitrogen preparations showed clearer cross-sections.

SEM images for gum base Sample No. 29 indicated possible spherical “domains”, as shown in FIG. 5, which is a 50 power magnification of a sample that was frozen in liquid nitrogen. It is believed that the spherical domains in the Sample No. 29 show PVAc, which made up 47.9% of the Sample No. 29 gum base. The spherical domains are clearly disrupting the gum base matrix.

SEM images for the Control gum base indicate possible spherical “domains” that appear smaller than those observed in gum base Sample No. 29. FIG. 6 is a 45 power magnification of a room temperature Control gum base sample. The Control Sample contained 25.9% PVAc and 16.2% filler. It is believed that these ingredients both contributed to the gum base matrix disruption seen in FIG. 6.

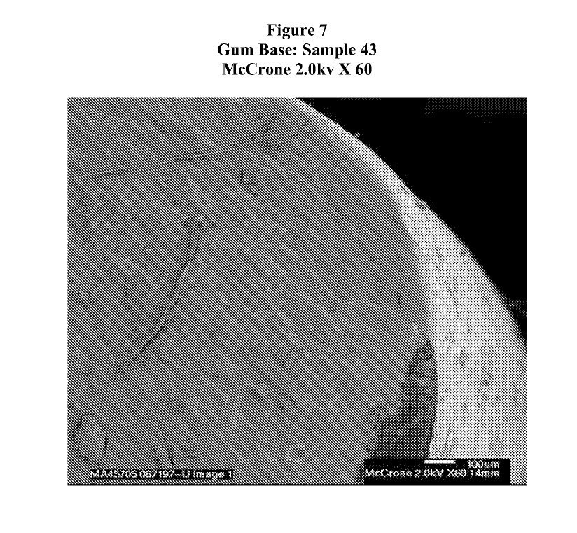

SEM images for gum base Sample No. 43 do not indicate any unique “domains” present. A 60 power magnification of a room temperature sample is shown in FIG. 7.

Some of the bases in the forgoing samples were used to make chewing gum compositions as follows:

### Gum Compositions

| | Exam- | Exam- | Exam- | Exam- | Exam- | Exam- |
|---|---|---|---|---|---|---|
| | ple | ple | ple | ple | ple | ple |
| | 44 | 45 | 46 | 47 | 48 | 49* |
| Base from | Control | 25 | 26 | 28 | 35 | 43 |
| Example | | | | | | |
| Total E & EP | 37.1 | 40.6 | 58.5 | 58.5 | 59.4 | 64.5 |
| Ratio | 0.88 | 1.09 | 2.24 | 2.24 | 6.99 | 161.3 |
| Gum Base, % | 33.0 | 33.0 | 33.0 | 33.0 | 33.0 | 33.0 |
| Sugar | 56.5 | 56.5 | 56.5 | 56.5 | 56.5 | 56.5 |
| Corn Syrup | 6.0 | 6.0 | 6.0 | 6.0 | 6.0 | 6.0 |
| Glycerin | 0.6 | 0.6 | 0.6 | 0.6 | 0.6 | 0.6 |
| Flavor | 1.6 | 1.6 | 1.6 | 1.6 | 1.6 | 1.6 |
| Triacetin | 0.6 | 0.6 | 0.6 | 0.6 | 0.6 | 0.6 |
| Encapsulated | 1.7 | 1.7 | 1.7 | 1.7 | 1.7 | 1.7 |
| Sweeteners | | | | | | |
| % Passing | 15 | 20 | 30 | 35 | 30 | 30 |
| when mixed | | | | | | |
| with chocolate | | | | | | |
| % Passing | 25 | 100 | 200 | 350 | 100 | 350 |
| when coated | | | | | | |
| with chocolate | | | | | | |

*Note: even with 35.1% vegetable oil softeners and emulsifiers in the base, Example 49 has properties with chocolate similar to gums made with high levels of polyisobutylene and lower level of vegetable oil.

The “% Passing when mixed with chocolate” in the Examples 44-49 refers to the results of tests that were carried out wherein the chewing gum composition was mixed with varying amounts of chocolate (in 5% increments) and masticated. After the gum composition was made and cooled, 50 grams of gum was smeared in a mixer at 50° C. for about 2-3 minutes and various increasing percentages of chocolate were added and mixed for another 1-2 minutes. Again gum was removed and cooled to room temperature for 24 hours. A total sample size of 2 grams regardless of the gum base or gum to chocolate ratio was sampled and chewed for 10 minutes and again rated for passing or failing.

The “% Passing when coated with chocolate” in the Examples 44-49 refers to the results of tests that were carried out that simulated what a coated product would be like. A piece of gum and varying amounts of chocolate (in 5% increments) were placed in the mouth together and masticated. The highest ratio of chocolate to gum that did not result in the gum loosing its cohesiveness within 10 minutes of chewing was the % Passing. As can be seen from the results reported above, the chocolate in a second region of the product, in this case simulating a coating on the gum composition, is separate from the gum. The amount of chocolate in the product in Examples 44-49 is at least 10%, by weight of the chewing gum in the product, greater than the amount of chocolate that, if mixed homogeneously in the chewing gum, would cause the chewing gum base to lose its cohesiveness when such a homogeneous product is chewed.

### Additional Examples

It may be preferable to make some embodiments of the present invention using a combination of some of the forgoing bases in order to optimize the chew characteristics of the product for consumer acceptability. The following gum bases may be made using 1/1, 3/1 and 1/3 ratios of the Sample 25 and Sample 43 gum base ingredients.

| | Sample 44 | Sample 45 | Sample 46 |
|---|---|---|---|
| Isobutylene-Isoprene | 2.8 | 2.4 | 3.1 |
| Copolymer | | | |
| Polyisobutylene | 11.4 | 10.1 | 12.8 |
| Calcium Carbonate | 0.4 | 0.4 | 0.4 |
| Terpene Resins | 38.3 | 34.0 | 42.7 |
| Polyvinyl acetate | 17.5 | 26.2 | 8.7 |
| Hydrogenated | 12.7 | 11.3 | 14.2 |
| Cottonseed Oil | | | |
| Hydrogenated Palm | 8.5 | 7.5 | 9.4 |
| Oil | | | |
| Glycerol Monostearate | 7.4 | 6.6 | 8.2 |
| Talc | 1.0 | 1.5 | 0.5 |
| Antioxidants | <0.1 | <0.1 | <0.1 |
| Total Elastomers | 52.5 | 46.5 | 58.6 |
| and Elastomer | | | |
| Plasticizers | | | |
| Total filler and PVAc | 18.9 | 28.1 | 9.6 |
| Ratio | 2.8 | 1.7 | 6.1 |

It is believed that the present invention is applicable to chewing gum products that include other fat-containing confections foods besides chocolate. For example, other confections, such as caramel, fudge, grained caramel, hi-chew, English toffee, chewy nougat, nut butters (such as peanut butter) and combinations thereof, may be able to be mixed into a chewing gum composition or otherwise incorporated into a chewing gum product using a gum base described above, and the product would be able to be chewed without the fat causing the gum base to dissolve in the mouth. Such fat-containing products may contain 5%, 10%, 15% or more fat by weight of the confection.

It should be appreciated that the method and products of the present invention are capable of being incorporated in the form of a variety of embodiments, only a few of which have been illustrated and described above. For example, fruit flavors may be used instead of the mint flavors in the examples. Even though the chocolate will frequently completely cover the gum piece, it will be understood that the term “coating” does not require such complete coverage. The invention may be embodied in other forms without departing from its spirit or essential characteristics. It will be appreciated that the addition of some other ingredients, process steps, materials or components not specifically included will have an adverse impact on the present invention. The best mode of the invention may therefore exclude ingredients, process steps, materials or components other than those listed above for inclusion or use in the invention. The described embodiments are to be considered in all respects only as illustrative and not restrictive, and the scope of the invention is, therefore, indicated by the appended claims rather than by the foregoing description. All changes that come within the meaning and range of equivalency of the claims are to be embraced within their scope.

1. (canceled)

2. The product of claim 9 wherein:
a) the piece of gum comprises a chewing gum center;
b) the coating comprising chocolate on the piece of gum comprises a first coating surrounding the chewing gum center; and
c) a second coating surrounds the first coating and comprising a hard shell made from one or more sugars, polyols and mixtures thereof.

3-8. (canceled)

9. A chocolate coated chewing gum product comprising:
a) a piece of gum fashioned from a chewing gum composition comprising
i) a gum base comprising about 2% to about 20% elastomer, about 10% to about 40% elastomer plasticizer, about 2% to about 25% gum base softener, and about 2% to about 10% emulsifier, the gum base containing less than 1% non-silica filler; and
ii) about 0.1% to about 5% flavoring agents; and
b) a coating comprising chocolate on the piece of gum.

10-15. (canceled)

16. A chewing gum composition comprising:
a) a gum base comprising:
i) about 2% to about 40% elastomer,
ii) about 10% to about 50% elastomer plasticizer, the combination of elastomer and elastomer plasticizer being at least 30% of the gum base;
iii) about 5% to about 35% gum base softener; and
iv) about 1% to about 10% emulsifier;
v) the gum base containing less than 10% filler;
vi) the gum base containing less than 45% gum base matrix disrupting materials;
b) about 0% to about 60% bulking and sweetening agents; and
c) about 5% to about 50% chocolate, said chocolate including at least 20% fat by weight of the chocolate, and the chocolate being admixed into the chewing gum composition.

17-21. (canceled)

22. A chewing gum composition comprising:
a) a gum base comprising:
i) about 2% to about 20% elastomer,
ii) about 10% to about 40% elastomer plasticizer,
iii) about 2% to about 25% gum base softener, and
iv) about 2% to about 10% emulsifier,
v) the gum base containing less than 1% non-silica filler;
b) up to about 60% bulking and sweetening agents; and
c) about 5% to about 80% of a fat-containing confection selected from the group consisting of caramel, fudge, English toffee, chewy nougat, nut butters, grained caramel, hi-chew and combinations thereof.

23-27. (canceled)

28. The chewing gum composition of claim 22 wherein the ratio of the combined total of any elastomer plus any elastomer plasticizers in the gum base to the combined total of any PVAc plus any filler in the gum base is at least 1:1.

29. The chewing gum composition of claim 22 wherein the ratio of the combined total of any elastomer plus any elastomer plasticizers in the gum base to the combined total of any PVAc plus any filler in the gum base is at least 2:1.

30-32. (canceled)

33. The chewing gum composition of claim 22 wherein the gum base elastomer is selected from the group consisting of butadiene-styrene copolymers (SBR), isobutylene-isoprene copolymers (butyl rubber), polybutadiene, polyisobutylenes, polyisoprene, and combinations thereof.

34-45. (canceled)

46. The chewing gum composition of claim 22 wherein the gum base comprises high molecular weight polyisobutylene.

47-57. (canceled)

58. The product of claim 2 further comprising a binder coating between the chewing gum center and the first coating, said binder coating comprising a binder selected from the group consisting of natural gums and their hydrolysates, hydrocolloids, modified starches, starch derivatives, cellulose derivatives, and mixtures thereof.

59. The product of claim 2 further comprising a binder coating between the first and second coatings, the binder coating comprising a binder selected from the group consisting of natural gums and their hydrolysates, hydrocolloids, modified starches, starch derivatives, cellulose derivatives, and mixtures thereof.

60-127. (canceled)
